(19) United States
(12) Patent Application Publication
(10) Pub. No.: US 2006/0058030 A1
(43) Pub. Date: Mar. 16, 2006

(54) Method for dynamically adapting radio signal strength threshold level in a subscriber radio based upon site type preference

(76) Inventors: Elizabeth M. Stephens, Pembroke Pines, FL (US); Kenneth E. Luippold, Davie, FL (US); David R. Mills, West Palm Beach, FL (US)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(21) Appl. No.: 10/939,396

(22) Filed: Sep. 13, 2004

(51) Int. Cl. H04Q 7/20

(52) U.S. Cl. 455/435.3

(57) ABSTRACT

A method for dynamically adapting a radio signal strength indicator (RSSI) threshold level of a subscriber radio in two-way radio communications includes determining pre-assigned subsystem site type (211) by a subscriber radio upon attempted registration with a subscriber radio subsystem site. The RSSI threshold level within the subscriber radio is then dynamically adjusted based on the subsystem site type. A predefined set of operational criteria is used by the subscriber radio to identify each subsystem site type and maintain predefined communication standards by either remaining within the subscriber radio subsystem site or being excluded from the subscriber radio subsystem site.

### TECHNICAL FIELD

This invention relates in general to two-way radio communications systems and more particularly to adjusting operational parameters of a two-way radio subscriber based on the dynamic adjustment of radio signal strength threshold levels.

### BACKGROUND

Large scale radio frequency (RF) communications systems are well known and are commonly used by state and local safety agencies to provide continuous, uninterrupted voice and data communications. These agencies most often include police and fire departments as well as other governmental services. The radio system is comprised of many radio trunked repeater sites that are networked in order to provide the most complete and seamless communications between the users. The ultimate objective is to have as few gaps in coverage areas as possible. One example of such a large-scale radio system is the SMARTZONE radio system manufactured by Motorola, Inc. Some sites within the system may have special applications. For example, a radio site may only be intended to cover a small geographic area. This type of smaller and more limited site may have a limited capacity by offering only several voice and data channels. It would not have the capabilities offered by the larger sites that are intended to cover a broader geographic area.

A subscriber radio determines what site to use based on a site “ranking” that it compiles while in use. Generally, it uses the site with the highest ranking to ensure the more optimal and uninterrupted communications. Prior art FIG. 1 illustrates the typical method used to determine when a subscriber is to roam and switch to an alternative site 100. As is well known in the art, a radio signal strength indicator (RSSI) is used to measure 101 the signal amplitude of the received signal from the radio site. This RSSI indication is used to determine a site's ranking. The subscriber radio determines if the RSSI has dropped below some predetermined threshold 103. If the RSSI measurement has not dropped below that threshold level 105, the ranking of the site in use will not change and the subscriber will not look for adjacent sites to obtain better signal reception that may have a higher ranking. However, if the RSSI measurement does drop below the predetermined signal level 107 the ranking of the site is lowered and the subscriber radio roams for a site with a higher ranking in order to obtain more reliable communications.

In many instances, a controlling agency such as a police department may dictate that certain channels or percentages of the radio system are to be used only for a specific purpose. For example, a police department may indicate that the majority of radio system capacity may only preferably be used for police radio traffic. Although this system capacity might be available for all users during an emergency, the police department may dictate that only access be limited for other agencies on a day-to-day, non-emergency basis. For example, some sites having limited resources might only be used by the police. In this situation, other “non-preferred” agencies might actually be precluded from accessing these radio sites.

Solutions to this problem have included using a single dedicated remote site not integrated with the larger communications configuration. An example of this approach may be Motorola's SMARTNET radio system. The drawback of using this type of system is that the user is limited to using only one dedicated site and cannot access the larger system. Another solution has provided that the larger radio system will define specific sites per talkgroup to be usable to the non-preferred user. Thus, when a non-preferred subscriber attempts to register with the site that is designed to be used only by one controlling agency, the subscriber radio will be rejected from accessing that site. Instead, the subscriber will be forced to roam to another available site. This approach also has a number of disadvantages which includes the lost processing time in having to roam and re-register to a new site. Also, after rejection by the site, the subscriber loses the capability of using the information provided by the rejected site. This information would enable the subscriber to quickly re-register with other alternative sites in the roaming process.

Thus, the need exists to provide radio subscribers, who normally have limited access to specific sites within a large scale radio system, with the ability to adapt their RSSI threshold so as to expand the scope of their use of the site or be excluded from a site by a controlling agency.

Considering the case of adapting the RSSI threshold to exclude a user from a subsystem, the radio may still roam to an excluded site if out of range of other subsystem sites. In this case, the radio may be further configured to treat such coverage as unavailable for all but emergency communications and roaming information. The radio may alert the user to “unavailable” coverage by using tones and/or display messages.

### SUMMARY OF THE INVENTION

Briefly, according to the invention, there is provided a method for dynamically adjusting radio signal strength indicator threshold level of a subscriber radio based upon a site ranking preference where the expanded use of a preferred site list allows a user to define a roaming subsystem within a larger communications system. The subsystem is defined in the subscriber radio through the use of a radio system software update. A subsystem can then be designed using the preferred site list on a per personality basis. Consequently, the subscriber radio will no longer need to gather information about subsystem boundaries from a radio site that might come about through site access denial. The method of the invention solves the problem of roaming through areas of unavailable access to the system, which may exist between two or more parts of the subsystem. Moreover, this subscriber radio enhancement may be used to dynamically remove a site-trunking site from a subsystem at the time the radio becomes aware of the wide-area site transitioning into a site-trunking condition.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 is a prior art flow chart diagram illustrating the methods used to roam for alternative radio sites based upon radio signal strength indicator (RSSI) measurements.

FIG. 2 is a flow chart diagram illustrating a method for dynamically adjusting RSSI level at a subscriber radio based upon site ranking preference in accordance with the preferred method of the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

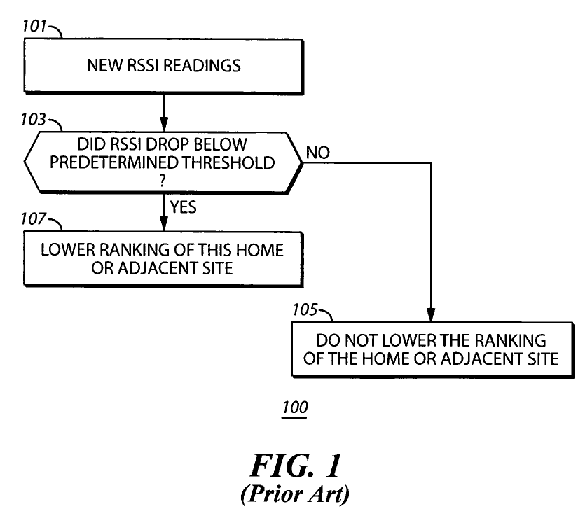

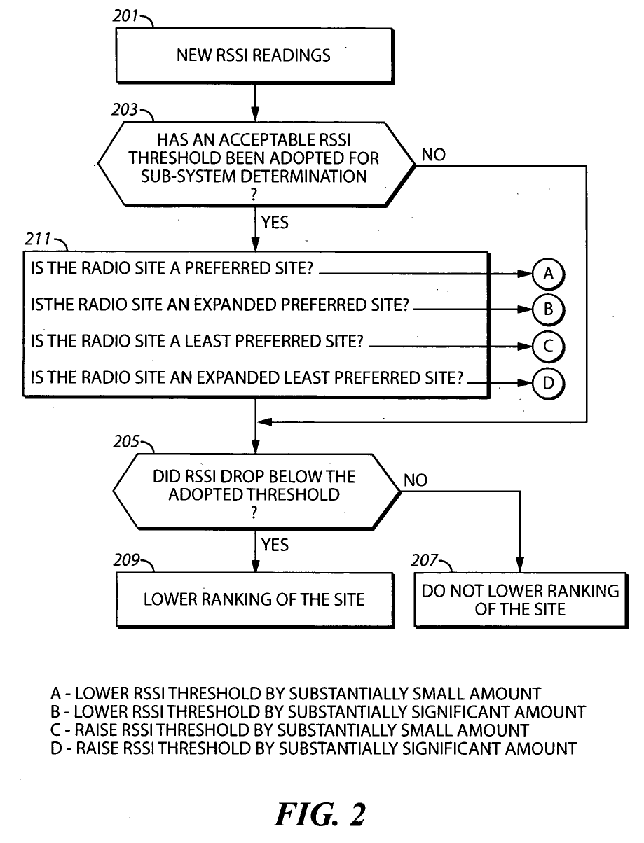

Referring now to FIG. 2, a flow chart diagram illustrating the preferred method for dynamically adjusting radio signal strength threshold level of a subscriber radio based upon site type preference 200 includes continually receiving and updating new radio signal strength indicator (RSSI) readings 201 based upon RF signals received by the subscriber radio. If a subscriber radio has been updated with the appropriate software updates and this software is activated in the radio's radio service software (RSS) 203, then the enhanced functionality of the method of the present invention may be realized. If the subscriber radio has not been updated or this functionality is not activated in the code plug, the method as shown in FIG. 1 is used to determine if the subscriber radio should locate an alternative site. These steps include determining if the RSSI measurement has dropped below a predetermined threshold 205 and then lowering the ranking of the used site 209 if the RSSI measurement is below the threshold or maintaining the ranking and remaining on that site 207 if the RSSI measurement is not lower than the predetermined level. In either case, the triggering event is when the RSSI measurement drops below the predetermined level.

When an acceptable RSSI threshold has been adapted for subsystem determination, i.e., this functionality has been added to the subscriber radio 203, the radio follows a number of predetermined criteria for dynamically adapting its operation based upon the type of radio site upon which it is used. Based upon the type of site, the subscriber radio will “rank” or prioritize the present site with which the subscriber radio is in communication as well as other alternative adjacent sites in the radio network. These sites are ranked in order to maintain communications within subsystem boundaries in the event that the subscriber roams. These subsystem radio site types include:
1) a preferred radio site;
2) an expanded preferred radio site;
3) a least preferred radio site; or
4) an expanded least preferred radio site

The radio determines the type of site based upon its designation information which is used by the subscriber radio to determine what protocol the subscriber radio will follow depending on RSSI indications. These steps are all described by step 211 where the subscriber radio will operate according to the type of site within which range it is operating.

If the radio site is a preferred site, then the acceptable RSSI threshold is lowered by some predetermined small amount in order to prevent the subscriber radio from choosing a non-preferred alternative site with similar RSSI acceptability. Thus, by using a preferred site the subscriber radio may extend the ranking of the preferred site as compared to a non-preferred site. This is especially useful for distinguishing between preferred and non-preferred sites on the same radio tower when close to site boundaries. The preferred site designation is used to steer radios to sites with more resources or to load sites with the same communications groups in order to affect loading in general. This feature is no longer susceptible to undesirable site switches when negligible RSSI differences are measured between a desired site and another less desirable site.

If the radio site is an expanded preferred radio site, then the acceptable threshold is lowered by a significant amount. This allows the radio subscriber to remain on a subsystem site even with a substantial reduction in RSSI level. Thus, the expanded preferred radio site would enable the radio subscriber to remain on a site with a very low RSSI in the event there are no other alternative sites that are part of the desired subsystem. This designation is used to provide a stronger steering mechanism than the regular preferred site. For example, the designation is recommended for defining a Motorola SMARTNET single site range within a larger Motorola SMARTZONE system.

If the radio site is a least preferred radio site, then the acceptable RSSI threshold is raised by some small amount. This, in essence, reduces the range of the non-preferred site as compared with the preferred site. It has the same use as extending the preferred site range to distinguish between preferred and non-preferred sites, especially to radio systems using the same radio tower. The least preferred site designation is used to steer radios away from sites with fewer resources or to load other sites with the same communications groups in order to affect loading in general. This feature is no longer susceptible to undesirable site switches when negligible RSSI differences are measured between a desired site and another less desirable site.

Finally, if the radio site is an expanded least preferred site, then the acceptable RSSI threshold is raised by a significant amount. Thus, a site of this type would not be used unless the radio subscriber is out of communications range of any alternative site. This designation is used to restrict access to a site. A radio may be configured to prevent communications on the expanded least preferred site and indicate unavailable coverage while the radio uses the designated site for roaming and emergency purposes. This site designation is similar in function to the existing Site Access Denial method of site steering with some significant improvements. The improvements are that the radio will not have to learn the accessibility of the site by visiting and handshaking with the system on the denied site and the site is still available for roaming and emergency purposes when no other sites are available.

Thus, the method of the preferred embodiment of the invention allows a subscriber radio to dynamically adjust its operation based upon RSSI threshold level where the threshold level is based upon a site type. Since system radio sites may be one of four separate types, this enables the subscriber radio to respond differently depending upon the type of site operation.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method for dynamically adapting a radio signal strength indicator (RSSI) threshold level of a subscriber radio in a two-way radio communications system comprising the steps of:
determining pre-assigned subsystem site type by a subscriber radio upon registration with a subscriber radio site;
dynamically adjusting the RSSI threshold level within the subscriber radio for the subsystem site type; and
utilizing operational criteria stored in the subscriber radio for each subsystem site type to maintain predefined communication standards for either remaining within the subscriber radio site or being excluded from the subscriber radio site.

2. A method for dynamically adjusting an RSSI threshold level as in claim 1, wherein the subsystem site type includes a preferred subsystem site that works to retain the subscriber radio within the subsystem site even at substantially reduced RSSI threshold levels.

3. A method for dynamically adjusting an RSSI threshold level as in claim 1, wherein the subsystem site type includes a least preferred subsystem site that works to exclude the subscriber radio from the site unless the radio has no usable subsystem site.

4. A method for dynamically adjusting an RSSI threshold level as in claim 1, wherein RSSI levels are measured on both a registered subsystem site as well as an adjacent subsystem site.

5. A method for dynamically adapting radio signal strength threshold level of a subscriber radio in a two-way communications system based upon subsystem site type preference comprising the steps of:
assigning at least one of a plurality of subscriber radio subsystem sites a subsystem site type;
measuring at a subscriber radio a radio signal strength indicator (RSSI) signal level from a plurality of subscriber radio subsystem sites;
attempting to register the subscriber radio with at least one of the plurality of subscriber radio subsystem sites;
determining by the subscriber radio the subsystem site type from the plurality of subscriber radio subsystem sites; and
dynamically adjusting an RSSI threshold level of the subscriber radio based upon the subsystem site type for determining alternative subscriber site preferences based on received RSSI levels.

6. A method for dynamically adjusting radio signal strength threshold level as in claim 5, wherein the subsystem site type is based on either raising or lowering the RSSI threshold level at the subscriber radio.

7. A method for dynamically adjusting RSSI threshold level as in claim 5, wherein at least one subsystem site type includes either a preferred site for lowering the RSSI threshold level to allow a subscriber radio to remain on the preferred subsystem site.

8. A method for dynamically adjusting RSSI threshold level as in claim 5, wherein at least one subsystem site type includes a least preferred site for raising the RSSI threshold level to prevent a subscriber radio from remaining on the non-preferred subsystem site.

9. A method for dynamically adjusting RSSI threshold level as in claim 5, wherein the two-way communications systems utilizes a plurality of trunked repeater subsystem sites.

10. A method for use with a trunked two-way radio communications system for dynamically adjusting the radio signal strength indicator (RSSI) threshold level of a subscriber radio depending upon the radio subsystem site type comprising the steps of:
assigning a radio subsystem site type designation to at least one of a plurality of trunked repeater sites;
determining the radio subsystem site type designation by a subscriber radio when attempting to register with the at least one of the plurality of trunked repeater subsystem sites;
selecting from a pre-assigned group of operational criteria stored within the subscriber radio based on the radio subsystem site type designation;
dynamically adjusting the RSSI threshold level within the subscriber radio depending on the operational criteria;
evaluating communications status between the subscriber radio and the at least one trunked repeater subsystem site; and
determining alternative site preferences based upon operational criteria and communications status.

11. A method for use with a trunked two-way radio communications system as in claim 10, wherein the step of evaluating communications status further includes the step of:
measuring an RSSI signal level on both a registered subsystem site as well as an adjacent subsystem site.

12. A method for use with a trunked two-way radio communications system as in claim 10, wherein the radio subsystem site type includes a preferred site that works to retain the subscriber radio within the subsystem site even at substantially reduced RSSI threshold levels.

13. A method for use with a trunked two-way radio communications system as in claim 10, wherein the radio subsystem site type includes a least preferred subsystem site that works to exclude the subscriber radio from the site unless the subscriber radio has a substantially increased RSSI threshold level.
